(19) United States
(12) Patent Application Publication
(10) Pub. No.: US 2015/0142518 A1
(43) Pub. Date: May 21, 2015

(54) SYSTEM FOR MAKING AVAILABLE FOR HIRE VEHICLES FROM A FLEET AGGREGATED FROM A PLURALITY OF VEHICLE FLEETS

(71) Applicant: MOBIAG, LDA., Torres Vedras, Silveira (PT)

(72) Inventor: João Tiago Farinha Gomes Félix, Lisboa (PT)

(21) Appl. No.: 14/403,123

(22) PCT Filed: May 22, 2013
(86) PCT No.: PCT/IB2013/054241

§ 371 Date: Nov. 21, 2014

(30) Foreign Application Priority Data
May 22, 2012 (PT) 106323

(51) Int. Cl. G06Q 30/06; G06Q 30/02; G08G 1/00

(52) U.S. Cl. CPC G06Q 30/0645; G08G 1/20; G06Q 30/0202
USPC 705/7.31

(57) ABSTRACT

The system developed intends to provide car-sharing operators with a management system for their operations that is at the same time highly functional but very flexible and easy to use. At the same time, such software is used by the requesting company for the management, control and optimization of the resulting network of providers. Such network arises from using this software to have multiple operators allowing roaming of their clients and assets thus creating a seamless network of vehicles to be used by all clients irrespective of which operator they have contracted the service.

The system comprises a plurality of interfaces, of which at least one for each of the vehicle fleet operator systems; a fleet tracking module; a zone management module; a multivariate vehicle supply and demand forecasting module; a reservations module, able to take into account the difference between forecasted supply and forecasted demand namely for non-firm reservations.

### TECHNICAL FIELD

The invention belongs to the technical field of fleet forecasting processes in the area of mobility, namely for optimization, operation and control of complex fleet networks.

### BACKGROUND

Car-sharing can be defined as a system of renting cars for short periods (typically less than 1 day and usually a few hours) without human intervention and the need for additional paperwork. Usually all costs are included in the rental fee (petrol, insurance, parking, etc) and billing is based on duration of usage. Having technology to intermediate these transactions lowers the transaction costs to a level where it makes sense for users and operators to allow for these short periods of usage (and corresponding low revenue per transaction) and makes it possible to introduce a new transport system to complement the existing heavy modes. Cars are traditionally parked on the street or in public access car parks and are accessed by members who identify themselves to the system namely by means of an RFID card or a mobile phone.

Presently there are four main operational models for car-sharing systems. The oldest, and therefore more established in the market, is the “round-trip” system, in which vehicles operate from a fixed point (a demarcated parking space) and all trips must initiate and end at that particular parking space. This model also states that users must book the car beforehand and, simultaneously, enter the time at which they will complete their journey, being billed for the time entered on the reservation and not actual time elapsed. These particularities result in low flexibility (and, thus, low functionality for the user) as most trips cannot be anticipated in the future with such a degree of certainty and most journeys do not begin and end at the same destination. This system is a result of an evolutionary (rather than disruptive) process applied to the pioneering “communal operators” which have existed since the 1960's. In the initial concept a true community of neighbours would purchase a car together and share acquisition and running costs and use it in turn (from this period the British inherited the term “car-club” and the concept of member). In the last 10 years newer versions of this model started to appear, leveraging new technologies in mobile communications, geo-positioning and Internet. We will focus, in turn, on the “bases model” and the “free-float model”, respectively. The “bases model” can be thought of as an evolution of the “round-trip model”. Although the user can now end the journey at a point other than the one where it initiated it is still confined to one of the systems' bases. The “bases” will typically be geographical points where multiple parking spaces will be available and where the operator can, potentially, provide an additional number of services to the users and the fleet. The state of the art example at moment is the recently inaugurated, electric car-only Auto'Lib operation in central Paris. This model, despite being much more functional than previous iterations, still misses two critical points in user experience—point-to-point trips where the end point is the clients' actual destination and availability of free spaces when a user arrives at the station, which in turn prompts the need for the user to book a free space, bringing back the need for anticipated planning and restriction of freedom. These problems can be mitigated but only at high infrastructural costs (increasing the number of bases and/or increasing the capacity of such bases).

The most recent evolution of the car-sharing concept, and the one that delivers enough functionality to answer users' mobility needs, is the “free-float” model. In this operational model, users can begin and end their journeys at their desired destinations anywhere inside a “geo-fenced” area of operation determined by the operator, without the need to pre-book pick-up or delivery times. This is what most closely mimics private car usage as we know it. The state-of-the-art example of this model is found in the Car2Go operations in Europe and North America. From a functional point of view this model can be considered the closest relevant, of the previously described models, to the present disclosure. From the user perspective, this system will be based on a multi-platform service (Web and Mobile), where the user will have real-time access to the available cars' location and can pick the one that better fulfils her needs for that trip. Once arrived at the vehicle, the on-board system will allow access to the vehicle (via an instruction from the central management system) and the user can then initiate her journey which will last for as long as needed, and finish at the users' intended destination as long as it is inside the allowed zone (which, is worth emphasising, is a major, positive distinction to the more traditional models). Presently, all existing operators, irrespective of the implemented model, present the same problem, namely they all work as closed systems (or “islands”). This means clients are limited to using only the vehicles made available by the operator to which it has contractualized the service. Therefore, in a competitive market, operators will under-invest in assets, to preserve a profitable occupancy rate, which in turn keeps functionality at a level unpractical to convince current private car users to switch to a shared system, thus perpetuating the low investment-low functionality cycle. It stands to reason that this market organization creates a vicious cycle problem where operators cannot guarantee sufficient demand to ensure profitable occupancy and, therefore, do not invest on the fleet. Limited vehicle availability hinders density, the key ingredient for functionality and service levels remain insufficient. Insufficient service levels (measured in geographical availability, inability to guarantee vehicle availability, etc) hinders mainstream adoption of the car-sharing concept, further compounding the demand problem. Despite what was just described, external market forces such as macro economic downturn and uncertainty, social changes towards car ownership and sustainability are converging to support growth of car-sharing as a mainstream mode of transport. Lastly, it's worth pointing out a parallel model of car-sharing which is growing substantially in the last 5 years, namely peer-to-peer car-sharing. As the name “peer-to-peer” indicate, car-sharing “operators” become client “management” platforms (some offering adjacent services to car owners, such as further insurance). Cars are made available by members, and such companies take care of client enrolment, transaction processing and marketing. Most services need a presential meeting between renter and owner which limits these systems functionality as a private car replacement, although this can change in the near future as on-board technology becomes cheaper and easier to self-install.

### SUMMARY

It is disclosed a system for making available for hire and for reserving vehicles from an aggregated vehicle fleet from a plurality of vehicle fleets over a predetermined area, comprising:
a plurality of fleet operator interfaces, of which at least one for each of the operator systems of said vehicle fleets;
a fleet tracking module for tracking the location and hire status of each vehicle, connected to said fleet operator interfaces;
a multivariate forecasting module of vehicle supply and demand for indicating the difference between forecasted supply and forecasted demand of the vehicles of the aggregated vehicle fleet for each vehicle class, for each geographical unit of the predetermined area, and for each period of time;
a reservations module, for hiring and changing the hire status of each vehicle of the aggregated vehicle fleet, able to accept non-firm reservations, taking into account if the difference between forecasted supply and forecasted demand is positive for the non-firm reservations for the vehicle class, for the starting unit of the predetermined area and for the starting period of time of the non-firm reservation.

In a preferred embodiment, the multivariate forecasting module comprises—as inputs—time, number of vehicle journeys, number of vehicle relocations, wherein the number of vehicle journeys comprises accepted and denied vehicle journeys, and comprises—as output—the difference between forecasted supply and forecasted demand for each geographical unit of the predetermined area.

In a preferred embodiment, the number of journeys input is split into two inputs, one input for accepted vehicle journeys and one input for denied vehicle journeys.

In a preferred embodiment, the forecasting module further comprises an input for the total number of aggregated fleet vehicles.

In a preferred embodiment, the forecasting module further comprises an input for the number of third-party backup vehicle journeys.

In a preferred embodiment, the inputs of number of vehicle journeys are inputs of the accumulated number of vehicle journeys.

In a preferred embodiment, the multivariate forecasting module is an artificial neuronal network, ANN, comprising input layer neurons for each forecasting module input and output layer neurons for each geographical unit of the predetermined area, in particular a RBF ANN.

A preferred embodiment further comprises a travel simulation model for providing input training data to the multivariate forecasting model, wherein said travel simulation model is configured to simulate travel journeys that are not capacity capped, from an input origin/destination matrix which comprises the number of journeys for each combination of origin, destination and time period.

In a preferred embodiment, the origin/destination matrix is a smoothed origin/destination matrix, which is smoothed in the three dimensions of origin, destination and time period.

A preferred embodiment further comprises a zone management module for defining preferential, neutral or disfavoured vehicle drop-off dynamical zones, within said predetermined area, for each vehicle of the aggregated vehicle fleet;

A preferred embodiment further comprises a billing module for billing reserved car hire journeys, configured to account for the preferential, neutral or disfavoured vehicle drop-off zones for each vehicle journey.

In a preferred embodiment, the multivariate vehicle supply and demand forecasting module is configured to indicate what preferential, neutral or disfavoured vehicle drop-off dynamical zones are to be created, modified or deleted, such that vehicle availability in preferential zones, or preferential zones and neutral zones, is maximized.

A preferred embodiment further comprises a database of vehicle location and status managed by the fleet tracking module configured such that for each vehicle aggregated from said vehicle fleet operators, a shadow vehicle is created, tracked and its location and status updated, so as to reflect the location and status of said vehicle in the vehicle fleet operator system.

In a preferred embodiment, the preferential, neutral or disfavoured vehicle drop-off dynamical zones for each vehicle are the same for more than one of the vehicle fleet operators.

A preferred embodiment further comprises a heat map analysis module configured to generate tasks such that to maximize vehicle availability in preferential zones, or preferential zones and neutral zones, such tasks comprising: indicating vehicle relocation, indicating high-demand zones, indicating incentive zones, and/or indicating zones for priority intervention.

In a preferred embodiment, each vehicle record of the aggregated vehicle fleet is marked according to its availability indicated by its corresponding vehicle fleet operator.

A preferred embodiment further comprises a central user registry database module interfaced with said vehicle fleet operator systems, comprising all user data.

In a preferred embodiment, the preferential, neutral or disfavoured vehicle drop-off dynamical zones for each vehicle are polygons.

A preferred embodiment further comprises a billing module configured to split journey bills between vehicle fleet operator and the reservation module operator, according to predetermined criteria and parameters.

It is also described a method for operating a system as any of the previously referred, comprising multivariate forecasting, by the multivariate forecasting module—from the inputs—time, number of vehicle journeys, number of vehicle relocations, wherein the number of vehicle journeys comprises accepted and denied vehicle journeys,—to the outputs—the difference between forecasted supply and forecasted demand for each geographical unit of the predetermined area.

In a preferred embodiment, the multivariate forecasting comprises training and evaluating an artificial neuronal network, ANN, in particular a RBF ANN.

A preferred embodiment further comprises simulating travel journeys for providing input training data to the multivariate forecasting, wherein said simulated travel journeys are not capacity capped and are simulated from an input origin/destination matrix which comprises the number of journeys for each combination of origin, destination and time period.

A preferred embodiment further comprises previously smoothing the origin/destination matrix by the three dimensions of origin, destination and time period.

It is also disclosed a computer readable medium comprising the computer program with computer program code adapted to perform any of the previously described methods when said program is run on a data processing system.

### DISCLOSURE

The system developed intends to provide car-sharing operators with a management system for their operations comprising Operations, Fleet and Customer Relations Management that is at the same time highly functional but very flexible and easy to use, with zero initial investment and low running costs. At the same time, such software is used by the requesting company for the management, control and optimization of the resulting network of providers. Such network arises from the possibility of using this software to have multiple operators allowing roaming of their clients and assets thus creating a seamless network of vehicles to be used by all clients irrespective of which operator they have contracted the service.

The main problems identified, and which this system intends to solve, include:
Low functionality of the actual systems and the difficulty in capturing enough resources, and managing associated risk, to build a car-sharing system under the free-float model, that offer sufficient functionality;
Chronic low occupancy rates of any operator in a competitive environment in the traditional (“island”) market organization. As the amount of users is finite, a market served by multiple functional “island operators” will be chronically over-dimensioned, and therefore, by definition will suffer from low occupancy rates and correspondingly low profitability, while not offering maximum potential functionality for users;
Low competition in the market leading to underperformance in service and price.

The disclosed system's, or herein referred as MobiAG's, proposed solution addresses these three issues in particular with aggregation. We can describe aggregation as a mechanism by which the entire fleet of shared vehicles available in a given area can be used by any client of the system, irrespective of which operator they have a commercial relationship with. To this end, it is disclosed a system to allow and promote the ability of clients to “roam”, a concept that can be described as the ability to use any vehicle available, but maintain only one commercial relationship, through which all visible interaction with the system will be processed.

Thus, one single entity has the capacity to access, process and analyze data relative to user demand in the past, the present and the future (through central reservations), as well as supply patterns resulting from users' journeys and using this information to manage resulting imbalances between both. This allows the manager of the aggregated system, to influence it, via its users, to maximise service and resource utilization and to manage, through complex, computer-implemented processes, the entire system in a unified, optimized way, something which is currently impossible in the “island” fleet structure, as no single entity has access to the full picture in terms of demand or the ability to direct resources to where they are most effective.

Aggregation presents many advantages further in this context. The ones most relevant to the solution of the above identified problems are described below.
Increased overall occupancy rate. Aggregation ensures that new entrants do not need to build out capacity to ensure minimum service levels to their clients, which in turn means less assets in the system leading to improves occupancy rates and thus, profitability. Paradoxically, in this case less assets in the system means improved service levels for clients (see below)
Users are able to use any available vehicle in the system. This means that more vehicles are made available, and consequently more choice and a higher statistical availability due to increased density.

The system operationalizes the previously discussed solution using its internally developed processes which are implemented as a software to manage all aspects of this aggregation. This materialises as:
Aggregate, dynamic and real-time management of supply and demand, to leverage the system's position as an entity functioning integrating and/or synchronizing the operators with access to all information;
Centralised processing of reservations deploying statistical modelling to ensure it is possible to implement anticipated reservations in a free-float market organization;
Capacity to interface, via encrypted and secure systems, with any external software that might be deployed by our clients, either new or existing, in case they do not want to migrate to our own operations management software
Operationalize, in real-time and on demand, the commercial conditions of different operators, thus enabling functional roaming while minimizing client-side complexity;
The capacity to support operations, manage, consolidate and segregate information, act as a clearing and compensation agent for a system supporting the operation of car-sharing.

In order to implement these processes the system may include data-mining and statistical forecasting algorithms able to process the vast amounts of data generated and extract the relevant insights. These algorithms are any of a class of self-learning and in continuous auto-improvement process as more data is processed and absorbed. Relevant external factors, such as events, metrological conditions, market geography and topography and advanced reservations (see below) are also fed into the algorithms along side system data. The expected outcome will automatically feed into other processes that monitor current system conditions to generate automated workflows designed to influence and modify user's behaviour with minimal human (administrator and operator) intervention.

The invention includes a number of solutions which address the challenges and opportunities that arise from this innovative market structure. Major identified challenges are detailed below:
Difficulty in accepting reservations for a distributed system in free-float mode;
Continuously and dynamically manage aggregated supply/demand on a system-wide level;
Aggregating partners operating different management software products
Creating efficient operational conditions for all operators to co-exist and thrive inside the platform irrespective of their size, as long as they are valid members providing a valued service.

The concept of advanced reservation currently presents a problem to all operators who work under the free-float model, as, by definition, it is not possible to book a specific vehicle for a given time as it is impossible to determine, with any meaningful degree of confidence, where that vehicle will be on the intended start time. Daimler recently dropped this service from its Car2Go operation in part because of difficulties in operationalizing this feature on their system. Again, roaming and density, coupled with intelligent software on the aggregator's side can successfully implement advanced reservation, a feature incredibly valued by system users, in a free-float model. Although reservations are not intended to be the primary method of usage, it is important that user know they can have this feature available much in the same way taxis can be hailed of the street or pre-booked. And the embodiments of the present disclosure have processes to implement this feature successfully.

A direct consequence of aggregating multiple operators, while allowing them to maintain full commercial and operational freedom, is the difficulty in managing distinct (or non-existent) operational areas, different and system promotions and pricing plans, clearing transactions between members inside and outside the platform and to consolidate and package this offering into a simple and functional service for the client. This challenge, of various is clear—because of revenue splitting and pricing decisions being made by the vehicle owner and not the client owner it is important to establish mechanisms to ensure that interesting and coherent strategies can be implemented by all while ensuring system stability and balance. Furthermore, the client will have to be well informed of the factors affecting the price of each journey beforehand, or during the journey if anything changes. This means real-time display of operational zones from vehicles inside and outside the platform at the moment of reservation, available and applicable promotions and managing the bewildering array of possible pricing combinations, taking into account commercial policies applicable to every different vehicle, to every different client and, if applicable any external entities.

### Operational Zones

The disclosure defines zones as a geographical area, for example delimited by a polygon, overlaid on a map of the relevant market where the user can terminate his reservation at no additional cost. Throughout the journey users can travel to any point, except to forbidden zones (which typically will be foreign countries and occasionally high-crime/dangerous areas). If the user wishes to terminate his journey at any point outside an operational zone he will be charged a variable fee designed to limit this behaviour and to make the operator whole for costs incurred with ferrying the vehicle back to an operational zone.

Operational Zones are defined by the operator on a vehicle by vehicle basis, using a Zone Management Interface on a CSO Management System. The process is as follows—when an operator first loads the vehicle into the central database it must define the operational zones for it, either from a pre-defined standard list (general city centre for a given market), from its own personalized list based on zones he is already using in for other vehicles, or by drawing a new zone, e.g. a polygon, in the Zones Management Editor. This flexibility is one of the most important features that allow a single system to support 4 distinct car-sharing models as previously presented. It is also important to note that a vehicle can have multiple operational zones (for operators with operations in multiple markets for instance) and that zones can be edited at any point in time in the CSO Management System. To enable External Partners, defined as partners of the system operating under external systems, who may not have zoning capabilities, the system will store zones for each vehicle to be applied to the “shadow vehicle” whenever it is logged on to the platform. The process of designing zones will happen when an External Partner initiates its relationship with the present disclosure system but the Partner's will have remote access to the Zone Management Editor should they wish to modify this at any point in the future.

It should be noted that the Zoning tool is one of the most instrumental in supply and demand management, particularly on the supply side. It accomplishes this by allowing the managing company to dynamically create “high demand zones” (where users have a benefit if they finish their journey inside that area) and “bonus areas”, typically next to a “high-demand” area, where users will have a bonus for starting their journeys (to incentivize a spreading of demand). An easily updatable Zoning tool also allows for longer-term supply management by allowing operators to swap vehicles between themselves and for an operator to change markets quickly and temporarily (like the transferring from the capital to the coast in Summer), thus allowing the system to adapt much faster to demand shifts.

The power of the Zoning tool is extended as it is via this module that Operators and External Entities can define “promotion zones”, zones where the conditions of the pricing plan or promotion apply. It is also with recourse to this tool that the system can create “High Demand Zones” that are posted to all operators, based on the supply/demand analysis and forecasting software discussed later.

Because of the natural complexity that arises from flexible systems, the present disclosure developed a process to display this information to the users in a simple and readily understandable way. The user, when choosing a car that fits his needs at any given time will, before concluding the reservation, be shown a map of the Operational Zone(s) for that particular vehicle. If his destination lies outside the Operational Zone she could or should choose another vehicle, or alternatively, supply the destination and be shown an estimate of the penalty cost so she can make a fully informed decision. In any case, it is preferred that if the user tries to close a reservation outside an Operational Zone she will always be shown the Penalty Fee value for that action and will have to accept it before closing his reservation.

### Integration

Integration is mostly accomplished by migrating (or creating new) operators on the present disclosure CSO Management Platform. This platform allows operators to use any of the 4 car-sharing models—as discussed above, round-trip, bases, free-float and peer-to-peer. Because fundamentally, all 4 need the same basic infrastructure and through careful parameterization of the Zones tool (see previous) allows operators to function on the model they feel most comfortable with—with an eye for full convergence to the free-float model in the future. This is particularly important to bring existing operations onto the platform and to leverage private vehicles as capacity-building blocks for the system as whole. For operators who choose to use a different management system the present disclosure includes a process (see FIG. 3) for interfacing any management software, irrespective of platform, to the present system. This may be based on a client-server architecture to optimize performance and resource usage on the client side and to preserve system security and data integrity as much as possible. It is believed that the devised process is unique in that it allows the present system to be fully utilized irrespective of technological capabilities of the clients' system, as it is possible to complement several shortcomings of current systems (lack of a zoning tool, or poor marketing campaign implementation options, for example).

### Forecasting

One-way car-sharing users are not obliged to return the car to the original pick-up location. This creates potential in-balances between areas, as travel demand is usually in-balanced (e.g. pendular movements from home to work in the morning peak time). This may be compensated by relocating cars from areas of forecasted low demand to areas of forecasted high demand (e.g. directly by employees or by providing user incentives like free rentals in order to increase drop-offs in the desired areas). As it necessitates time and resources to move the required cars, it is usually necessary to forecast demand such that high demand is met by previously initiating the relocation of cars such that these will be available when required.

Optionally, pick-ups and/or returns maybe carried in specific base stations, though the more general and difficult problem does not have base stations.

Existing optimization methods suffer from robustness as small differences between reality and forecasting models provide markedly inferior real-life results.

Demand involves 4 main factors—number of clients, number of vehicles, time and location. Car demand (clients requiring a car) and car supply (vehicles available) are connected in a way that goes beyond classical supply/demand linkage, as a car rental involves dropping off the car at a different location after a specific time lapse—thus changing the supply pattern of vehicles. Furthermore, the definitive availability of the vehicle is only known when the drop off is completed.

A forecasting module is thus described for the above purposes.

A density map is used that links supply and demand, such map having space and time dimensions. The content of the map is the imbalance, whether actual or forecasted, between supply and demand. Such a map can be two-dimensional grid representation of space (see FIG. 10). Such a map can also represent base-stations—if used—by mapping a specific cell to each base-station. As the grid map will usually cover a large area, with multiple sub-areas of interest, the number of cells (columns by lines) is normally fairly large.

A multivariate vehicle supply and demand forecasting model is suitable for this task. In some embodiments, the forecasting may be split according to vehicle class by using multiple models, one for each class.

One of the suitable multivariate models is a model comprising artificial neuronal networks (ANN), in particular of the type Radial Basis Function (RBF) as these are well suited for models with a large number of outputs. One of the suitable RBF ANN models involves three neuron layers one layer for inputs, one layer for outputs and a middle layer of so-called ‘hidden’ neurons.

The input data in most embodiments comprises vehicle journeys: actual client journeys (demand that was met), staff vehicle relocations, denied client journeys for lack of supply (unmet demand), maximum available supply (number of fleet vehicles), demand met by use of third-party backup fleets (e.g. taxy journeys) whereas the output data comprises the quantity of the difference between forecasted supply and forecasted demand for each geographical map unit (or cell).

Preferably, one of the inputs is time (or time-period), such that the remaining inputs and outputs are then correlated by the training data set to a specific time.

A typical embodiment is shown in FIG. 11, but the disclosure is pertinent to other embodiments in this case, 3 input layer neurons (time, accumulated total journeys, accumulated total relocations), 4 hidden (intermediate) layer neurons and as many output layer neurons as map units.

The number of hidden layer neurons is defined according to methods known in the art, usually the number of hidden layer neurons that produces the best quality forecasts and does not over fit the training data set (in particular, the minimum of hidden layer neurons that attains these two goals).

Inputs and/or outputs are preferably normalized to a standard scale, in some embodiments between 0 and 1. Obviously, when obtaining normalized forecasted results the output must then be converted to actual real-life scale. For example, when the time input is normalized, it will range from 0 to 1. In particular, 0 will correspond to the first time instant being forecast (e.g. 6 am) and 1 will correspond to the last time being forecast (e.g. 10 pm). In particular, it may also range in discrete steps according to each time period (e.g. if there are ten time periods to be forecast, the input will be 0.0, 0.1, 0.2, . . . 0.9, 1.0).

In some embodiments, the output neurons are preferably each related to a specific grid cell. The number of cells (or inversely, the size of the cells) is a compromise between better detail (more cells, smaller cells) and lighter computational workload (less cells, larger cells). In some embodiments, time is preferably not an output of the output neurons of the model.

In some embodiments, when operating the forecasting module, outputs can have negative values, in particular when the inputs and training set comprise all possible demand—negative values simply show unmet demand (demand outstripping capacity).

In particular, three inputs can be used—time (or time-period); total demand (number of journeys, whether accepted or rejected); number of relocations. In particular, the number of journeys and number of relocations are the accumulated total from the first forecasting time.

Optionally, the total demand (number of journeys) input can be split into two separate inputs—accepted journeys (met demand) and rejected journeys (unmet demand). In particular, these are the accumulated total from the first forecasting time.

Optionally, a further input can be added—maximum available supply (number of fleet vehicles). This number is usually constant; not varying along the forecasting period, but it may indeed vary because of vehicle malfunction or planned maintenance, where vehicles are removed from the available car pool. Furthermore, in the case of aggregation of various car pools, the number of vehicles may vary substantially along the forecasting period—because the number of vehicles available for aggregation is beyond the control of the aggregating car pool.

Optionally, a further input can be added for demand met by the use of third-party backup fleets (e.g. taxy journeys). In this case, the demand that was met by the use of third-party backup fleets may be not included in another demand input (e.g. accepted journeys—met demand).

The outputs reflect car availability vs demand. Optionally, in the training phase of the forecasting module the vehicles may be scattered randomly at the beginning of the forecasting period—this enables that the full map is used for training and avoids any potential bias. For the training phase, relocations may be carried out using simple heuristics or more complex rules or systems—it is preferred that relocations are carried out using the same rules/criteria during both training and forecasting phases.

Optionally, during the training phase the size of the fleet may be artificially very high such that only rarely, or never, do capacity constrains occur. This has the advantage that the training is phase is not biased by a limited capacity and will better predict in the operation phase all potential demand.

The various input/output formats described have the advantage of being particularly compact forms that provide the required output detail, while at the same time using straightforward input variables. In the training phase, the forecasting module incorporates the required output maps. In operation, the forecasting module is fed using overall operation parameters (e.g. number of journeys), not requiring in-depth knowledge (e.g. specific origins, destinations, durations or lengths of specific journeys). This way the model, while providing robust forecasts, is very straightforward to use, easy to implement, reliable and predictable.

In some embodiments, as the neuronal network topology does not require that an actual grid is used, other 2-D cell layouts are thus possible, for example making each cell correspond to a specific urban or city area (which usually are not part of a grid, e.g. London boroughs).

In some embodiments, separate forecasting models are used according to the timescale involved. Though the same model can be used to forecast all time periods along the desired forecasting timescale, say a week, preferably different cascading models are used. For example, some embodiments comprise combining a day model using periods in minutes or hours, with a week model using periods in hours or days, and, optionally, with a seasonal model using periods in weeks or months.

When the system aggregates the supply/demand of multiple car-pool providers, relocation policies may be very different. Thus, it is an advantage that the forecasting model comprises relocation data and is able to accommodate different relocation policies of each sub-pool, by simply including such relocations in the forecast.

When the system aggregates the supply/demand of multiple car-pool providers, in some embodiments, ‘shadow-cars’ may be used. As these do not have to comply with the same rules of the system's own car pool, managing this supply and demand is more difficult. Thus, it is an advantage that the forecasting model comprises own car pool travel data and third-party car travel data as it is then able to accommodate these different car pools, by simply including such travel data in a global forecast.

### Travel Simulation as Forecasting Input

A travel simulation model is described below for the purpose of providing input training data to the forecasting model described above.

In order to train the forecasting model, travel data is required but it should be understood that actual travel data reflects the supply that was available in the specific settings where such data was collected. If the vehicle availability is to be improved by the present embodiments, then actual travel data reflects inferior availability and may not be of enough quality in order to, in turn, produce better quality forecasts by the forecasting module.

In short, if the actual available travel data is capacity-capped, then it may not provide the best basis for forecasting models that aim at improving capacity availability. Thus, a second model that simulates travel based on actual available travel data is preferably used in some embodiments for training the first model, having the advantage of providing travel data that is not capacity capped to the forecasting model. Having obtained an origin/destination matrix, see FIG. 12, for the probability of travel for each origin/destination pair, for each time period, this is used as an input.

In some embodiments, the origin/destination matrix is smoothed by using an appropriate smoothing algorithm of those known in the art (least squares, another neuronal network, among others). For example, taking origin from line 1 of FIG. 12, one obtains the probability of destinations as in FIG. 13. This can be smoothed and normalized as in FIG. 14. This is an example, as smoothing is preferably carried out in three dimensions (origin, destination, time) of the matrix.

By inverse sampling the accumulated origin/destination probability matrix, a journey can then be simulated—by inverting the accumulated probability curve and a lookup based on a random number generation. Preferably, though not mandatory, the time period is first determined and then the origin/destination is determined (two-step approach).

The travel simulation model also has the advantage of providing input data to the forecasting model, even when no actual data is available (for example, bootstrapping the forecast model when no existing car-sharing system data is available).

### DESCRIPTION OF THE FIGURES

The following figures provide preferred embodiments for illustrating the description and should not be seen as limiting the scope of invention.

FIG. 1: Schematic Representation of the Central Reservation Engine

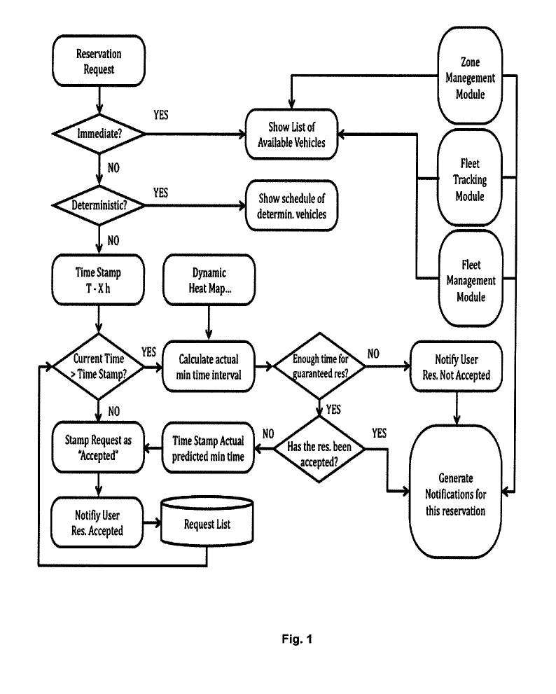

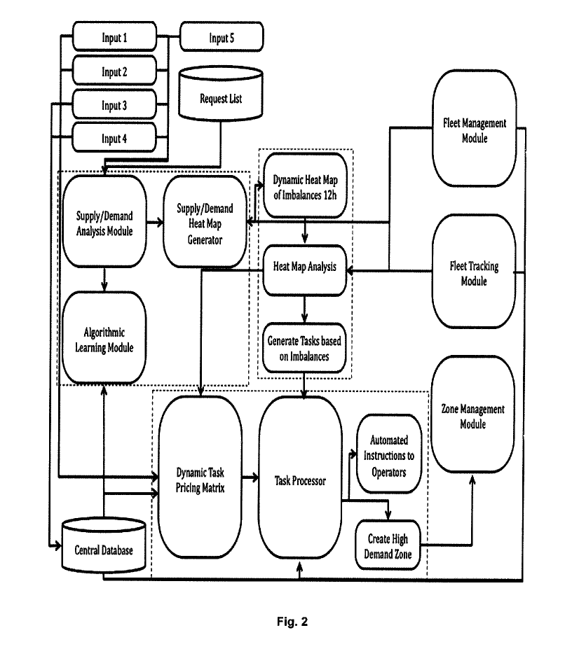

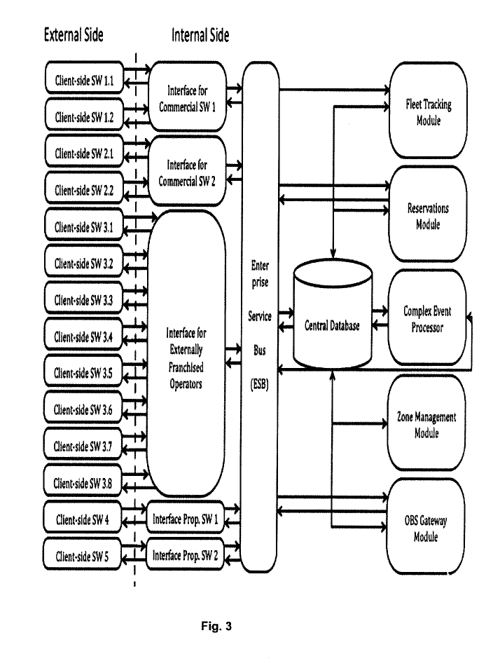

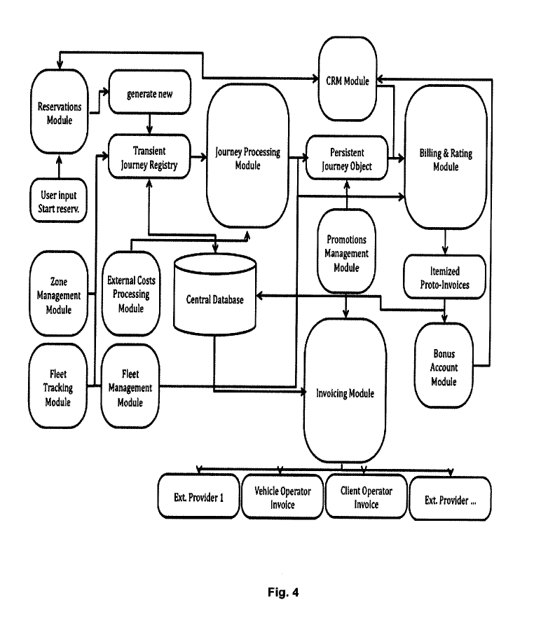

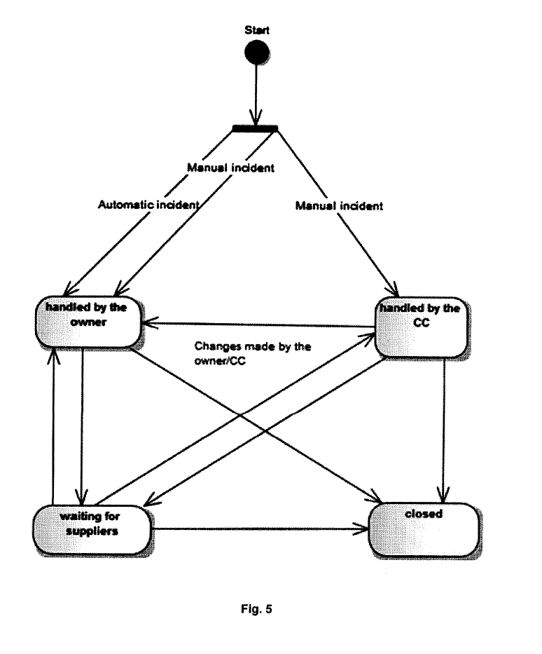

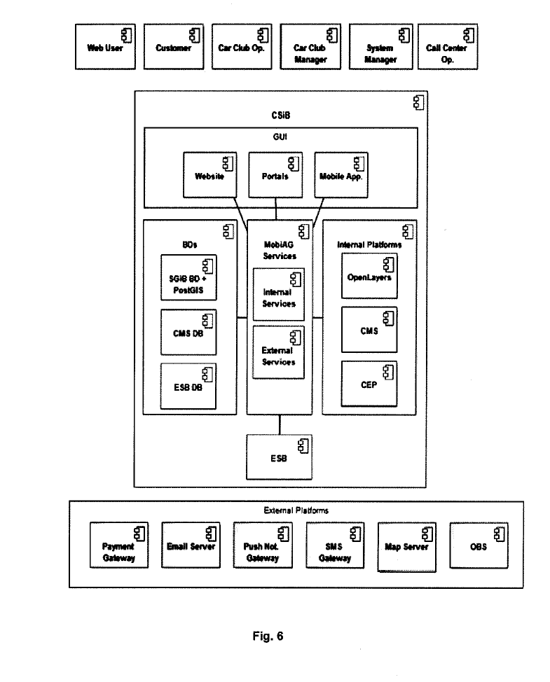

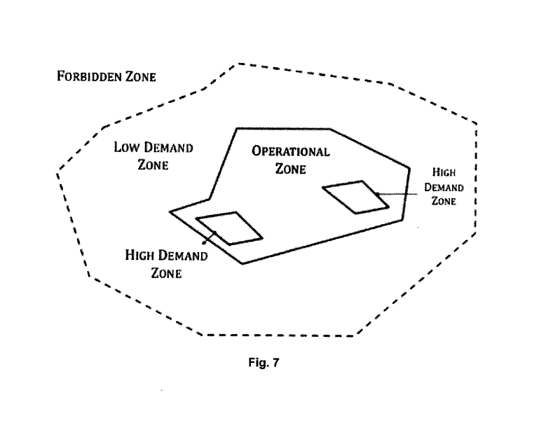

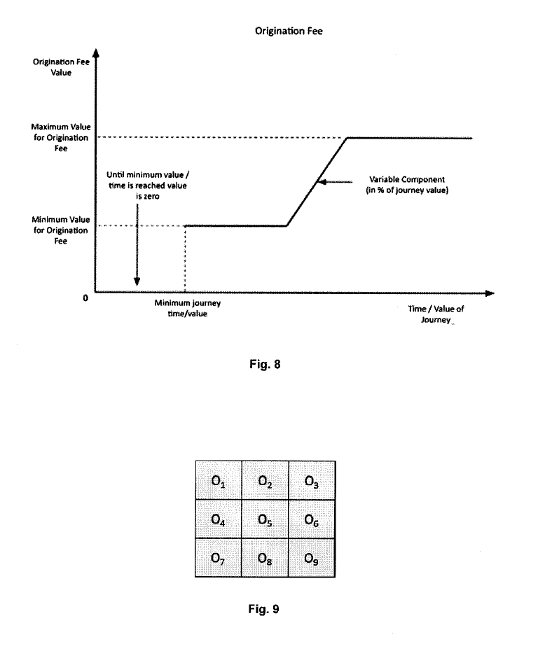

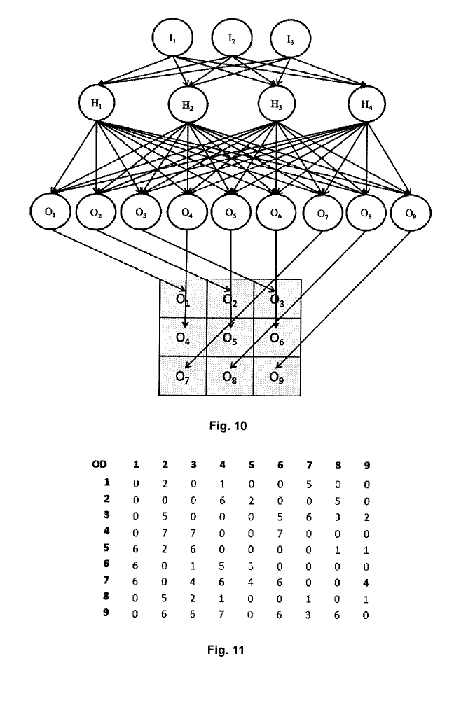

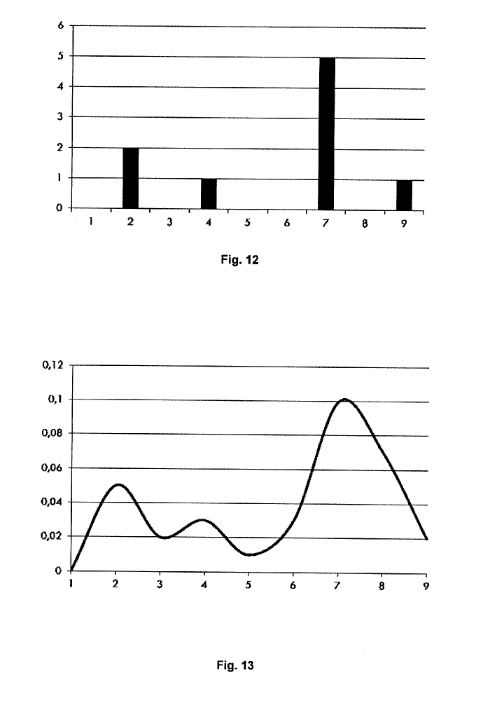

The Central Reservation Engine is the implementation of a key process in the successful management of an aggregated car-sharing system. The Engine receives an input from an end user, who is previously authenticated and authorized to perform reservations in the system. In the first step, the user must define intended start location, intended start time, intended vehicle class (optional) and how many notifications he wishes to receive, as well as via which channel. The reservation process begins with the user selecting whether he is looking for an immediate reservation, i.e. a car to start using right now or an anticipated reservation, where usage will not happen immediately. If he picks immediate reservation he will be shown a list (or map, depending on the chosen view) of available vehicles, real-time location of said vehicles and respective details, including price plan, operational zones, etc. Users can then choose their preferred vehicle and initiate a reservation (see FIG. 1.1).

However, if the user chooses to perform an anticipated reservation, he must first choose if this is a “Deterministic” reservation, where he will be guaranteed a specific vehicle on his reservation date (except in rare cases where the previous user might have not arrived on time or the vehicle had to be taken out of operation). These vehicles must be picked from a small pool of operators who will work under the “round-trip” model previously discussed, and, hence, can determine at any point in time whether the vehicle will be available or not. To this end, the user must state in the reservation process not just his pick-up time, but also the drop-off time, and must, naturally, perform a return trip.

If he picks the third option, the client will not be performing a true “reservation” in the strict sense of the word, but he will be flagging an intention of using a vehicle at that specific point in time. We may refer to this process as “Statistical Reservations” or non-firm reservations.

After the user submits his request, the request will be logged and a time stamp of [Reservation Start Time−X hours], where X varies with vehicle class and is such that a statistical certainty, say 99%, exists that a vehicle meeting the reservations' criteria will be available, will be logged with that entry. Immediately after, this request will be tested to check whether the time stamped time is in the past or the future relative to current time. If in the future, user will be notified that his request has been accepted and the request will marked “Accepted” and logged in the database for later processing. If the current time stamp is in the past, the system will calculate the expected minimum time interval to obtain at least one positive match to the request criteria with over statistical certainty, say 90%. This expected time is obtained from the Dynamic Heat Map, generated by the Supply/Demand Management System, for the specific class of vehicle, in the intended start location and for the intended reservation start time. After this step, the request enters the second test where the time difference between current time and reservation start time will be tested against the calculated minimum time interval. If the minimum time interval is longer than the difference between current time and reservation time the user will be notified that the reservation is not accepted and the request becomes an active search process where the user receives notifications whenever a vehicle that matches the request is available. If the minimum time interval is shorter than the difference between current time and reservation time the system tests whether this request has been previously accepted or not. The test looks for the “Accepted” stamp that was added to the request after the first test. If the request has not been stamped “Accepted”, it gets stamped with the actual calculated minimum time, stamped as “Accepted” which generates a notification to the user and it gets logged on the database for later processing. If it been previously accepted, then the request becomes an active search process where the user receives notifications whenever a vehicle that matches the request is available. Requests that were logged on the database are sorted from shortest to longest difference between current time and time stamp time and will be continuously fed, in a linear fashion, through the first decision step to test whether the condition that current time is still before time stamp time, thus re-entering the loop.

FIG. 2: Schematic Representation of Dynamic Multivariate Supply/Demand Forecasting and Management System

The Dynamic Multivariate Supply/Demand Forecasting and Management System comprises the core processes used to actively manage the system to attain the stated goals of service level and occupancy rate maximization. The System is built around three distinct sub-systems, that not only interact within this system, but also publish information to be used by other modules and systems. The three main sub-systems are: Modelling and Forecasting Algorithmics, Imbalance Analysis and Tasking, Active System Management. The first of these sub-systems is the most innovative in its conception and application to the problem of managing an aggregated mobility system. It comprises 3 main modules: the Algorithmic Learning Module (ALM), the Supply/Demand Analysis Module (SDAM) and the Heat Map Generator Module (HMGM).

The first module is dedicated to continuous improvement and analysis of the algorithms used to predict supply/demand. This module will pull historical data from the central database of the Inputs to be used in forecasting, namely, Time of day, year, month, calendar day, week day, used to discretize and compare seasonality, scheduled events that impact demand, such as school holiday periods or public holidays, and unscheduled events like public transport industrial action or a music festival. Furthermore, as anyone who has had to commute on a rainy day will know, the weather is a large influencer of demand for these types of services and it may be an input as well as geo-topographical and demographical data for the market being analysed (this will be obtained from the central database as well since it is not expected to be dynamic). Both historical series and current values (needed for the next step) are organized in some embodiments in a star-based architecture running on top of a data-mart solution. Historic series of these inputs feed into the Algorithmic Learning Module and present and forecasted values of the same variables will be inputs for the Supply/Demand Analysis Module. Finally, the ALM pulls historical demand and supply from the central database as historical reservations, trips with start point in the segment and density maps for each segment divided by car class. This division is of paramount importance as car classes will be skewed and for clients it's very important to be able to choose the type of car that is convenient to them. The ALM uses, in some embodiments, algorithms based on Multiple Linear Regression and Artificial Neural Networks for situations with solid historical data and relies on a third algorithm, based on a Hidden Markov Model (or other Bayesian network models) to improve performance in transient periods. These algorithms are Learning Algorithms and by continuous analysis of actual system behavior and comparison with forecasted system behavior (continuous feedback loop) are self-improving, increasing performance over time. It is important to state that is some embodiments it is expected to use similar algorithms across markets but that each segment may then have specific parameters that will be continuously tuned for better forecasting performance. Finally, these algorithms are used to construct an Ensemble Forecast, a forecast that combines all forecasts produced by the different algorithms to obtain a single forecast with variance smaller than the variance of any of its components.

The following module, Supply/Demand Analysis Module, takes the forecasting algorithms produced by ALM and feed into them all the above mentioned information (Inputs 1 through 4), optionally plus any requests registered on the database for the analysis period, returning the expected number of vehicles and the expected demand for vehicles in each discreet segment of the grid (e.g. segments will start at 1 km-side squares, and resolution may be improved over time). These forecasts can be made for each segment, for each vehicle class and in, e.g. 15 minutes, intervals which means approximately 59,000 segment calculations per day just for an embodiment for Central London, by any means a daunting task and one that needs optimization of the algorithms so that the hardware necessary to accomplish this will be within reach of a small scale organization. The expected result of this Analysis is a segment-by-segment forecast of the difference between available vehicles and demanded vehicles, which may be referred to as the Supply/Demand Imbalance. Furthermore, treating the same set of results using a different statistical model it is intended to be able to accurately forecast (say, to within 95% confidence) the average time between vehicles of each class, a result that is very important in most embodiments for the functioning of the previously described Reservation Engine.

Based on the imbalances generated by the previous module, the third model of the Modelling and Forecasting Algorithmics sub-system will generate a “heat map” for the close future time, say the next 12 h, defined as a geographical map on top of which will be overlaid the segment grid, for example with each segment coloured a specific shade based on the size (and positive or negative sign) of the imbalance. It is this map that is shown to operators in the notification part and, coupled with the tasks generated by the Active System Management sub-system, allows operators and the central system to dynamically influence both supply and demand using pricing (namely through the mechanism of micro-promotions and reward points). It also feeds through to the Imbalance Analysis and Tasking sub-system for processing and analysis.

Once the map enters the Imbalance Analysis and Tasking sub-system it is processed by the “Heat Map Analysis” module. This module uses tracking and Fleet management inputs to calculate if any current trips can be finished in the areas of greater need and, for imbalances detected early, prepare the tasks for owners to send out to the Task Market or to specific service providers, such as relocating a specific class of vehicle or redistribute a higher concentration than needed. The output is a list of actionable tasks (a task includes vehicle ID, start point, finish point and compensation, for example) aimed at operators which actively contribute to a more efficient running of the aggregate system.

The previous output finally enters into the final stage of analysis, Active System Management. The system now has a list of tasks for the next few hours (depending of what is determined by the analysis module) but not all have the same value to the system and, hence, are worth the same compensation. The operator of the system of the present disclosure, as aggregator, is in a position to attribute a value to each task based on its relevance to the system and revenue potential. This ranking and valuation is performed by the Task Processor Module (TPM) which receives inputs from the Heat Map Analysis module and a “helper” module called “Dynamic Task Pricing Matrix” (DTPM). DTPM will receive the same hyperspace-defining inputs as Algorithmic Learning Module (ALM) and the Supply/Demand Analysis Module (SDAM) so as to be able to characterize segments correctly and more return more accurate forecasts that actually take into account the full set of variables in use throughout the system

FIG. 3: Schematic Representation of External Partners Interface System

As been previously discussed, the system of the present disclosure is able to offer to its clients a Car-sharing Operations Management System. Because some operators may be reluctant to give up their legacy systems and because of the system's nature as an aggregator it may need to be ready to interface with said systems.

Integration starts with a operator-side client that will read the clients equivalent of the Central Database whenever queried by the its system-side server pair. The client software will also be responsible for “translating” any information it posts to the server to the system's data structure to ensure onward compatibility. This client-server architecture limits hardware load and improves data security for both sides. On log-on, the Interface system will create “shadow” cars in the system's Fleet Management Module and any interaction from the system's clients with an external vehicle will be handled as if it were a system vehicle, with all information pertaining to the vehicle and the trip being recorded on the system's platform. Once a vehicle is in use, the system's server will either ping the vehicle's On Board Systems directly or will regularly ping the External Partner's system for the minimum required information (depending on technological solutions employed and commercial agreements). In case the External Partner's system does not support zoning, the system will suggest to the Partner, during the initial stages, to define a operator-level zone that will be stored in the system and will be activated whenever the “shadow” cars are logged on to the system.

“Shadow” cars are in some embodiments implemented by communicating car availability asynchronously. This has the benefit of requiring lower computational resources and allowing a less strict use of the available car pools thus taking advantage of the forecasting model. Aggregated car-pools periodically publish to a central server only general information—car ID (e.g. license plate), car availability status (free/busy), current location. Thus, no full data is published or communicated, e.g. future reservation data or maintenance periods. The forecasting model takes these cars into account together with all other supply data. Preferably, when a booking is confirmed by a user, the system “pings” the car (confirms with the on-board system) that the vehicle is still available, because availability is not strictly managed (there is no future booking) and the car may have been taken by someone else in the meantime.

FIG. 4: Schematic Representation of the Journey Rating & Billing Engine and Invoicing System

The implemented process that enables operations in roaming, aggregation of multiple operators and service providers by processing of all transactions performed inside the present disclosure's system is based around the Journey, as previously described. The Journey object is created by the Reservations Module after a user gives the command to reserve a vehicle and this command is validated by the CRM Module, and exists in two states, a transient one that exists only for the duration of the transaction and a persistent one that records processed information. The first state registers all relevant information generated by system in a raw state. Recorded information includes start and finish time, start and finish time of motor running, all location points sent by the vehicle OBS and any incidents that generate automated reporting, initial fuel and final fuel, identification of the vehicle used, etc. Periodically, for example every 10 minutes, or once the user finishes the journey and the vehicle is reported as vacated, the system will automatically process this information (or a copy thereof in case the journey is still running) in the Journey Processing Module. This module is responsible for calculating the relevant data from the raw data, including journey time, distance travelled, fuel consumption, itinerary plus logging any incidents or events (positive and negative) that might have been generated on this journey. This data is stored in the persistent state of the Journey object and is used to rate the journey in the next step, the Billing & Rating Module.

The system proposed has been described mainly based on the free-float model, but its flexibility allows it to enable any of the 4 operational models to ensure easier acceptance from incumbents and individuals.

The described embodiments are combinable.

1. A system for making available for hire and for reserving vehicles from an aggregated vehicle fleet from a plurality of vehicle fleets over a predetermined area, comprising:
a. a plurality of fleet operator interfaces, of which at least one for each of the operator systems of said vehicle fleets;
b. a fleet tracking module for tracking the location and hire status of each vehicle, connected to said fleet operator interfaces;
c. a multivariate forecasting module of vehicle supply and demand for indicating the difference between forecasted supply and forecasted demand of the vehicles of the aggregated vehicle fleet for each vehicle class, for each geographical unit of the predetermined area, and for each period of time; and
d. a reservations module, for hiring and changing the hire status of each vehicle of the aggregated vehicle fleet, able to accept non-firm reservations, taking into account if the difference between forecasted supply and forecasted demand is positive for the non-firm reservations for the vehicle class, for the starting unit of the predetermined area and for the starting period of time of the non-firm reservation.

2. A system according to claim 1, wherein the multivariate forecasting module comprises—as inputs—time, number of vehicle journeys, number of vehicle relocations, wherein the number of vehicle journeys comprises accepted and denied vehicle journeys, and comprises—as output—the difference between forecasted supply and forecasted demand for each geographical unit of the predetermined area.

3. A system according to claim 2, wherein the number of journeys input is split into two inputs, one input for accepted vehicle journeys and one input for denied vehicle journeys.

4. A system according to claim 2, wherein the forecasting module further comprises an input for the total number of aggregated fleet vehicles and an input for the number of third-party backup vehicle journeys.

5. (canceled)

6. A system according to claim 2, wherein the inputs of number of vehicle journeys are inputs of the accumulated number of vehicle journeys.

7. A system according to claim 2, wherein the multivariate forecasting module is an artificial neuronal network, ANN, comprising input layer neurons for each forecasting module input and output layer neurons for each geographical unit of the predetermined area, in particular a RBF ANN.

8. A system according to claim 2 further comprising a travel simulation model for providing input training data to the multivariate forecasting model, wherein said travel simulation model is configured to simulate travel journeys that are not capacity capped, from an input origin/destination matrix which comprises the number of journeys for each combination of origin, destination and time period.

9. A system according to claim 7, wherein the origin/destination matrix is a smoothed origin/destination matrix, which is smoothed in the three dimensions of origin, destination and time period.

10. A system according to claim 2 further comprising a zone management module for defining preferential, neutral or disfavoured vehicle drop-off dynamical zones, within said predetermined area, for each vehicle of the aggregated vehicle fleet;

11. A system according to claim 2 further comprising a billing module for billing reserved car hire journeys, configured to account for the preferential, neutral or disfavoured vehicle drop-off zones for each vehicle journey.

12. A system according to claim 2, wherein the multivariate vehicle supply and demand forecasting module is configured to indicate what preferential, neutral or disfavoured vehicle drop-off dynamical zones are to be created, modified or deleted, such that vehicle availability in preferential zones, or preferential zones and neutral zones, is maximized.

13. A system according to claim 2 further comprising a database of vehicle location and status managed by the fleet tracking module configured such that for each vehicle aggregated from said vehicle fleet operators, a shadow vehicle is created, tracked and its location and status updated, so as to reflect the location and status of said vehicle in the vehicle fleet operator system.

14. A system according to claim 2, wherein the preferential, neutral or disfavoured vehicle drop-off dynamical zones for each vehicle are the same for more than one of the vehicle fleet operators.

15. A system according to claim 2 further comprising a heat map analysis module configured to generate tasks such that to maximize vehicle availability in preferential zones, or preferential zones and neutral zones, such tasks comprising: indicating vehicle relocation, indicating high-demand zones, indicating incentive zones, and/or indicating zones for priority intervention.

16. A system according to claim 2, wherein each vehicle record of the aggregated vehicle fleet is marked according to its availability indicated by its corresponding vehicle fleet operator.

17. A system according to claim 2 further comprising a central user registry database module interfaced with said vehicle fleet operator systems, comprising all user data.

18. A system according to claim 2, wherein the preferential, neutral or disfavoured vehicle drop-off dynamical zones for each vehicle are polygons.

19. A system according to claim 2 further comprising a billing module configured to split journey bills between vehicle fleet operator and the reservation module operator, according to predetermined criteria and parameters.

20. (canceled)

21. A method for operating a system as referred in claim 1, comprising multivariate forecasting, by the multivariate forecasting module—from the inputs—time, number of vehicle journeys, number of vehicle relocations, wherein the number of vehicle journeys comprises accepted and denied vehicle journeys,—to the outputs—the difference between forecasted supply and forecasted demand for each geographical unit of the predetermined area.

22-24. (canceled)

25. A computer readable medium comprising the computer program with computer program code adapted to perform the method of claim 20 when said program is run on a data processing system.
